(19) United States
(12) Patent Application Publication
(10) Pub. No.: US 2002/0188890 A1
(43) Pub. Date: Dec. 12, 2002

(54) System and method for testing an application

(76) Inventors: Eric A. Shupps, Roanoke, TX (US); Kirk H. Wilson, Dallas, TX (US); Jonathan Swartz, Dallas, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/161,879

(22) Filed: Jun. 4, 2002

Related U.S. Application Data
(60) Provisional application No. 60/295,646, filed on Jun. 4, 2001.

(51) Int. Cl. H04B 1/74; H02H 3/05

(52) U.S. Cl. 714/38

(57) ABSTRACT

A process can be used to test an application. In general, the process can include a transaction definition portion, a validation portion, and an optional modification portion. Unlike the conventional processes, the testing can be performed using “scriptless” transactions. The transaction definition may occur during navigation by a user through a network site while data regarding application is collected. Alternatively, a user may select transactable components or transactions from a list or a group of icons. In still another alternative, the transaction definition may be performed automatically using log files or component relationship data. Validation may be performed in-process or out-of-process to give greater flexibility. Modification may be performed manually or automatically. Also, modification may be performed after validation has started but before it is completed.

### RELATED APPLICATIONS

This application claims priority under 35 U.S.C. §119(e) to U.S. Patent Application No. 60/295,646 entitled “System and Method for Functional and Integration Testing of Web Applications and Components” by Shupps et al. filed Jun. 4, 2001. This application is related to United States Patent Application Nos. (Attorney Docket No. SENT1100-1) entitled “Method and Computer System for Isolating and Interrelating Components of an Application” by Shupps et al., (Attorney Docket No. SENT1100-3) entitled “System and Process for Constructing and Analyzing Profiles for an Application” by Shupps et al., and (Attorney Docket No. SENT1100-4) entitled “System and Process for Visual Representation of an Application” by Shupps et al., all filed of even date. All applications cited within this paragraph are assigned to the current assignee hereof and are incorporated herein by reference.

### FIELD OF THE INVENTION

This invention relates in general to testing of applications, and more particularly, to testing code for an application designed to be used on a network to determine its functionality and performance.

### DESCRIPTION OF THE RELATED ART

The traditional approach to functional testing involves an integration-focused process known as “script recording.” This process involves the definition of a base customer profile, identification of the most common actions such a user would perform while interacting with the application, recording of the steps required to complete each defined action in a controlled environment, and the playback of these steps via measurement and monitoring software. In this manner, site owner/operators can gauge application functionality and performance as it relates to a given set of user actions.

Script recording can identify each step in a trail of actions and provide data on an individual or collective basis. However, the recorded data is limited as it only applies to the exact steps that have been defined, excluding all other options. Should functional issues arise in areas not reached by scripts, they go unrecognized and unreported. Script-recording is also static, being made of pre-defined actions, and therefore, is unable to compensate for dynamic application responses that change based on available input, session state or other fluctuating parameters. If, for example, a page component identified in a transaction step changes, the script must be manually re-recorded and replayed to achieve consistent results.

In addition, the script-recording process is both cumbersome and inefficient, requiring a tremendous investment in both time and resources to identify, plot, and record user actions before testing can commence. An extensive, complex site with hundreds, if not thousands, of dependent components would require a large number of scripts to test each variable, which in turn would require a significant team of quality assurance personnel to manage the overall process. Eventually, the sheer number of variables outpaces the ability of a manually generated process to achieve even the most basic level of accuracy. Use of such tools has proven to be ineffective in a constantly fluctuating Web-based environment. Some of the problems are better understood with an example.

In a typical scenario, the user can initiate a test by launching the script-recording application and defining a new action sequence. The application invokes a web browser (if the tool is client-side resident; if a service, the user is likely already accessing the application through a browser), from which the user can perform the steps comprising a transaction. For purposes of this illustration, assume that the transaction is a purchase, whereby the user navigates to the site, performs a text search, identifies the proper search result, enters data in a sequence of forms and completes the transaction by returning to the starting point.

To create this scenario, the user must physically navigate the site through the browser while the script-recording application “watches,” recording each step as a sequence of data requests/responses. For example, the process may resemble the following:

Begin Transaction→

1. HTTP GET request for the specific URL.

2. Processing of the data by the host (via server-side script, object, or other handler).

3. Transfer of data to client (usually contains new URL with associated parameters).

4. Manual selection of a page component.

5. Data entry into a text field on an HTML form (the Boolean search).

6. Manual initiation of an event (clicking the ‘Submit’ button).

7. A FORM POST to transmit the data to the host.

8. Processing of the data by the host (via server-side script, object, or other handler).

9. Transfer of data to client (usually contains new URL with associated parameters).

10. Manual selection of page component (proper search result).

11. HTTP GET request for the specific URL (or other parameter).

12. Processing of the data by the host (via server-side script, object, or other handler).

13. Transfer of data to client (usually contains new URL with associated parameters).

14. Manual selection of one or more page components.

15. Manual initiation of an event (clicking the ‘Submit’ button).

16. A FORM POST to transmit the data to the host.

17. Processing of the data by the host (via server-side script, object, or other handler).

18. Transfer of data to client (usually contains new URL with associated parameters).

19. Repeat 14-18 for all forms in sequence (product options, shipping and billing information, confirmation, etc.).

20. HTTP GET request for the starting URL.

←End Transaction

This sequence would then be translated into the test script, which is a text-based representation of the actions performed by the user, the sequence the actions were performed in, and the data required to perform each step. Test scripts may be stored in memory, as a computer file, or as a structured document (such as JavaScript, HTML, or XML). Regardless of the process in which they are stored, test scripts generally exhibit a consistent set of properties, such as:

1. A static structure that defines a sequence of actions.

2. A set order in which to perform the sequence.

3. The data necessary to perform each action.

4. The expected result of each action.

5. Validation logic for comparing expected results against actual results.

6. An output or reporting mechanism.

The user would then save the transaction and create another, run the test immediately or schedule the test to be run at a later date. After initiated, the actual test itself would be made of script playback by the testing application. Various analysis mechanisms would be employed at this stage, usually including time-to-complete metrics for each step, comparison of returned content during the test run to returned content during the recording phase, identification of any errors encountered, and pass/fail statistics. The results would then be displayed in an application interface as a series of reports, screens, tables, graphs, or other visual process.

Again, some of the bigger problems with test scripts are the effort involved in manually composing and modifying the test scripts. The process is labor intensive and can cause programmers that may otherwise be developing or improving existing code to be relegated to script writing.

### SUMMARY OF THE INVENTION

A process for testing an application that, in general, can include a transaction definition portion, a validation portion, and an optional modification portion. Unlike the conventional processes, the testing can be performed using “scriptless” transactions (i.e., without necessarily using scripts).

The transaction definition may occur during navigation by a user through a network site while data regarding the application is collected. Alternatively, a user may select transactable components or transactions from a list or a group of icons. In still another alternative, the transaction definition may be performed automatically using log files or component relationship data. Validation may be performed in-process or out-of-process to give greater flexibility. Modification may be performed manually or automatically. Also, modification may be performed after validation has started but before it is completed.

In one set of embodiments, the process can comprise generating a transaction definition for a transaction that can be performed using the application and validating the transaction. In one embodiment, the transaction definition may not be part of a script file.

In another set of embodiments, the process can comprise identifying a component within the application. The component may be part, but not all, of a document. In one specific embodiment, the component is not a link. The process can also comprise generating a transaction definition for a transaction that can be performed using the application and validating the transaction.

Embodiments may include a data processing system readable medium having code embodied therein, which code is designed to generate prospective information for an application designed to be used on a network. The code of the data processing system readable medium can comprise instructions for carrying out the processes described.

The foregoing general description and the following detailed description are exemplary and explanatory only and are not restrictive of the invention, as defined in the appended claims.

### BRIEF DESCRIPTION OF THE DRAWINGS

The invention is illustrated by way of example and not limitation in the accompanying figures.

FIG. 1 includes an illustration of a client computer and a server computer as part of a computer network.

FIG. 2 includes an illustration of a data processing system storage medium including software code having instructions in accordance with an embodiment described herein.

FIG. 3 includes a flow diagram for testing an application used on a network in accordance with an embodiment described herein.

FIGS. 4-7 include flow diagrams for identifying components and relationships between components for rendered source code that is designed to be used on a computer network.

FIG. 8 includes a flow diagram for generating a transaction definition by navigating a network site.

FIG. 9 includes a flow diagram for generating a transaction definition by selecting transactable components within the application.

FIG. 10 includes a flow diagram for testing an application using an in-process validation process as described herein.

FIG. 11 includes a flow diagram for testing an application using an out-of-process validation process as described herein.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Reference is now made in detail to the exemplary embodiments of the invention, examples of which are illustrated in the accompanying drawings. Wherever possible, the same reference numbers will be used throughout the drawings to refer to the same or like parts (elements).

A few terms are defined or clarified to aid in understanding the descriptions that follow. A network includes an interconnected set of server and client computers over a publicly available medium (e.g., the Internet) or over an internal (company-owned) system. A user at a client computer may gain access to the network using a network access provider. An Internet Service Provider (“ISP”) is a common type of network access provider. A network address includes information that can be used by a server computer to locate information, whether internal to that server computer or at a different, remote computer or database. Uniform Resource Locators (“URLs”) are examples of network addresses.

A network site typically includes documents, network pages, files or other information displayed at different network addresses for that network site. A web site is a common type of network site, and a web page is a common type of network page. The network site may be accessible using a client-server hardware configuration. Documents may consist of the individual software program(s), code files, scripts, etc. An application typically includes a plurality of documents that are network pages, and a network domain may include a plurality of applications. Note that the examples given within this paragraph are for purposes of illustration and not limitation.

The system and method for testing an application is applicable to web-enabled applications. A “web-enabled” application is one that operates over HTTP (or similar) Internet protocol and can be accessed or manipulated using an Internet browser such as Netscape Navigator or Microsoft Internet Explorer. Web-enabled applications may include Internet applications, E-commerce based systems, extranets, and other similar types of applications that use network based technologies. For purposes of this invention, the term “application” is defined to include a web site and its constituent parts, including but not limited to, code, scripts, static and dynamic web pages, documents, calls to other programs/files/data and software programs, designed to reside on, and be accessed or utilized via a network, such as the Internet.

For purposes of this invention “components” are subparts of an application; thus components include the individual parts that make up a document and may be links, form fields, images, applets, etc. Components can also refer to a set of related, lower level components. An order form is an example of a component that may include a set of other components, such as a name field, an address field, a payment field, an image of a product being ordered, etc. As can be seen by the example, the components within the order form have a child-parent relationship with the order form.

The term “contextual relationship” is intended to mean a relationship within a single document. For example, an anchor tag, commonly known as a bookmark, which is a link on a page leading to another location in the same page, would exhibit a contextual relationship with the document in which it is located. The term “cross-contextual relationship” is intended to mean relationships extending outside a single document. A cross-contextual relationship may exist between two components on different network pages within the same domain or a link to a page or other component at a different domain.

For the purposes of this invention, a “document” is defined to include a document or other information displays at different network addresses for that network site. A web site is a common type of network site, and a web page is a common type of document. Note that the examples given within this paragraph are for purposes of illustration and not limitation.

Numerical identifiers may be used to identify specific articles or other items (e.g., first component, second component, etc.) described or claimed herein. The numerical identifiers are used for labeling convenience and do not imply an order of performance or relative position unless stated to the contrary.

As used herein, the terms “comprises,” “comprising,” “includes,” “including,” “has,” “having” or any other variation thereof, are intended to cover a non-exclusive inclusion. For example, a process, method, article, or apparatus that comprises a list of components is not necessarily limited only those components but may include other components not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In general, the process for testing an application can include a transaction definition portion, a validation portion, and an optional modification portion. Unlike the conventional processes, the testing can be performed using “scriptless” transactions. In this way, the time and expense of having to manually generate and modify script files can be reduced or eliminated.

The transaction definition portion may be as simple as using the application to navigate through a network site while data regarding application is collected. Alternatively, a user may select transactable components or transactions from a list or a group of icons. In still another alternative, the transaction definition may be performed automatically using log files or component relationship data. Validation may be performed in-process or out-of-process as is described in more detail later in the specification. Modification may be performed manually or automatically. Also, modification may be performed after validation has started but before it is completed.

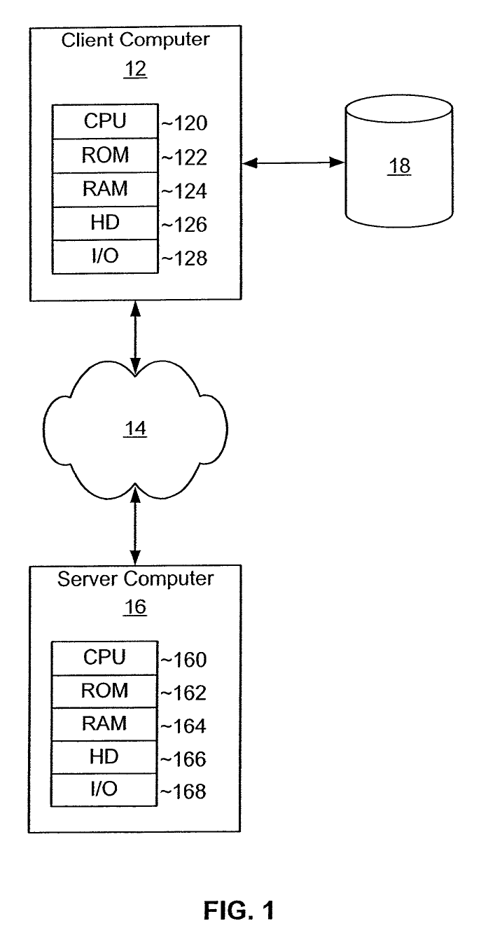

Before discussing embodiments of the invention, an exemplary hardware architecture for using embodiments is described. FIG. 1 illustrates an exemplary architecture and includes a client computer 12 that is bi-directionally coupled to a network 14 (e.g. the Internet)and database 18, and a server computer 16 that is bi-directionally coupled to the network 14. The client computer 12 includes a central processing unit (“CPU”) 120, a read-only memory (“ROM”) 122, a random access memory (“RAM”) 124, a hard drive (“HD”) or storage memory 126, and input/output device(s) (“I/O”) 128. The I/O devices 128 can include a keyboard, monitor, printer, electronic pointing device (e.g., mouse, trackball, etc.), or the like. The server computer 16 can include a CPU 160, ROM 162, RAM 164, HD 166, and I/O 168. The server computer 16 may have a cache memory that resides in RAM 164.

Each of the client computer 12 and the server computer 16 is an example of a data computer system. ROM 122 and 162, RAM 124 and 164, HD 126 and 166, and the database 18 include media that can be read by the CPU 120 or 160. Therefore, each of these types of memories includes a computer system readable medium. These memories may be internal or external to the computers 12 and 16.

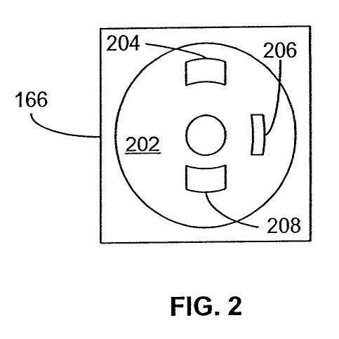

The processes described herein may be implemented in suitable software code that may reside within ROM 122 or 162, RAM 124 or 164, or HD 126 or 166. In addition to those types of memories, the instructions in an embodiment of the invention may be contained on a data storage device with a different data computer system readable storage medium, such as a floppy diskette. FIG. 2 illustrates a combination of software code components 204, 206, and 208 that are embodied within a computer system readable medium 202, on HD 126. Alternatively, the instructions may be stored as software code components on a DASD array, magnetic tape, floppy diskette, optical storage device, or other appropriate computer system readable medium or storage device.

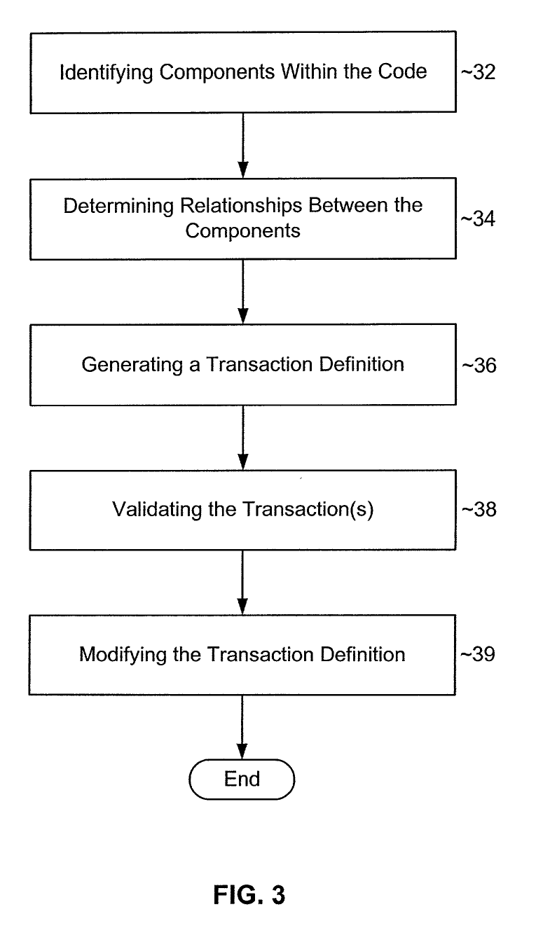

In an illustrative embodiment of the invention, the computer-executable instructions may be lines of compiled C++, Java, HTML, or any other programming or scripting code. Other architectures may be used. For example, the functions of the client computer 12 may be incorporated into the server computer 16, and vice versa. Further, other client computers (not shown) or other server computers (not shown) similar to client computer 12 and server computer 16, respectively, may also be connected to the network 14. FIGS. 3-11 include illustrations, in the form of flowcharts, of some of the structures and operations of such software programs.

Communications between the client computer 12 and the server computer 16 can be accomplished using electronic, optical, radio frequency signals, or other methods of communication. When a user is at the client computer 12, the client computer 12 may convert the signals to a human understandable form when sending a communication to the user and may convert input from a human to appropriate electronic, optical, radio frequency signals, etc. to be used by the client computer 12 or the server computer 16.

Similarly, when an operator is at the server computer 16, the server computer 16 may convert the signals to a human understandable form when sending a communication to the user and may convert input from a human to appropriate electronic, optical, or radio frequency signals to be used by the server computer 16 or the client computer 12.

Attention is now directed to processes for generating prospective information regarding an application designed to be used on a network. Although not required, the application being profiled and analyzed may be rendered source code in a mark-up language (e.g., HTML) to be rendered by a browser.

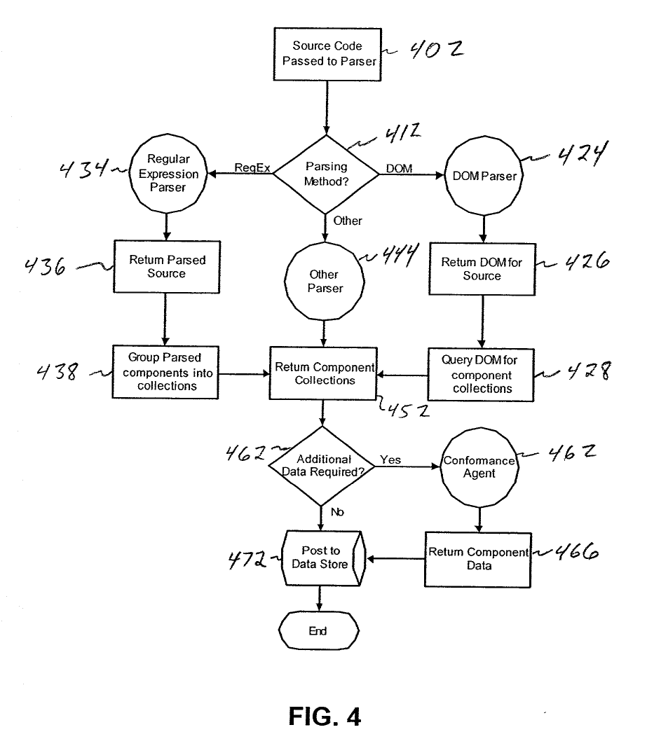

In one embodiment, the process of the present invention can comprise identifying components within the application (block 32) and determining relationships between the components (block 34) as shown in FIG. 3. The process can also comprise generating a transaction definition (block 36), validating the transaction(s) (block 38), and modifying the transaction definition (block 39). The identification of components and component relationships may be performed using the processes described and illustrated in FIGS. 4-7. The profile may be constructed from test data collected on the components and the component relationships. The profile may also include information related to metadata that describes how the test data was collected when the rendered source code was executed by a client browser. In many embodiments, the analysis of the profile may comprise generating prospective information including scenario modeling, predictive analysis, forecasting, scalability estimation, combinations thereof, derivations thereof, or the like.

As a non-limiting example, the process can be used for an application that includes software program(s) or code that operate a network site or a significant portion thereof, such as an Internet web site. The application, when presented by the server computer 16 can generate rendered code that may be transmitted over the network 14 to the client computer 12. The rendered code may be in a markup language including HyperText Markup Language (“HTML”) or any of the well known variants, extensible Markup Language (“XML”) or any of its variants, Wireless Markup Language (“WML”) or any of its variants, or any other current and future markup, scripting, or programming languages. A software program on the client computer 12, such as a browser, can use the rendered code to display information to the user at the client computer 12 via an I/O device 128.

Unlike most other methods of gathering data on Internet software applications, the rendered code may be evaluated at the client computer 12 instead of assembling information from the original code at the server computer 16. Harvesting information at the client computer 12 can better reflect the experience and potential responses of actual users. Additionally, as the rendered code at the client computer may be entirely different from the original code, information gathered from the rendered code may uncover errors or other potential problems that would not be seen if data was obtained from the pre-execution code at the server computer 16.

Attention is now directed to details of identifying components (block 32 in FIG. 3) and determining relationships between the components (blocks 34 in FIG. 3) of the application.

Components may have parent-child relationships as previously described in the definition section. Components may be further separated into two types: transactable and non-transactable. Transactable components are those components upon which a user may act to produce a result. Examples of transactable components are hypertext links, scripts, image maps, forms, and applets. Non-transactable components, in contrast, are those for which no user input is required, an example of this may be a static, unmapped image.

After the rendered code is retrieved (block 310), the process can include parsing the code to identify components within the code as shown in FIG. 4. This process includes: choosing which type of parsing method is going to be utilized (diamond 412), returning the collection of components assembled from the parser (block 452), determining if additional data is required on any of the components discovered (diamond 462), and posting the results of the parsing to a data store (block 472).

As an example, consider the following rendered code. Bolded text and arrows below are notations for various components within the code, but are not part of the

[image]

The code can be passed to a parser (block 402) and a determination is made regarding which parsing process will be used (diamond 412). The parsing may be performed using a regular expression parser (circle 434), a Document Object Model (DOM) parser (circle 424), or another type of parser (circle 444). As shown, the components are those portions of the application identified after the parsing process has been performed.

Regular expressions can be programmatic components that enable the complex manipulation, searching, and matching of textual components. The extensive pattern-matching notation of regular expressions allows an application to quickly parse large amounts of text to find specific character patterns; to extract, edit, replace, or delete text substrings; or to add the extracted strings to a collection in memory.

Regular expressions may be used to isolate components in documents, such as files coded in HTML or XML, by matching the pattern of content descriptors, known as “tags,” and text structures. For example, a regular expression that extracts hyperlinks from the code may resemble the following:

<A.*?href=[‘”]?([\mathring{}’”\s>]+)[‘”]?[\mathring{}>]*?>(.*?)</A>

The result of executing the expression on the rendered code may include the following:

1. http://www.anysite.com

This example demonstrates the identification of an anchor component (the <A> and </A> tags) and the value associated with the component (the text between the tags that matches the structure defined in the expression). The same principle may be applied to any valid tags within the document language as well as free-form text that adheres to a fixed pattern or style. The parsed code can be returned (block 436), and the parsed components can be grouped into collections (block 438) where all the components match a certain regular expression associated with a type of component, for example a hypertext link, or the grouping may consist of one file or collection of all components discovered by the regular expression parser. The grouped component collection(s) can then be returned (block 452).

Attention is now directed to the DOM parser (circle 424). The DOM (part of the HTML 3.0 specification) can be a specification for how objects in a document are presented. The DOM can define what attributes are associated with each object, how the objects can be defined, and how the objects and attributes can be manipulated. The DOM may be used to identify page components by comparing the document structure to the data components specified in the DOM. In addition to exposing available components, the DOM may also contain the methods and properties available for each component and permit new object definitions, such as those found in XML documents, to be introduced without prior specification. Most, if not all, components which may comprise an application will be within the DOM.

Although the DOM is a standard World Wide Web Consortium (“W3C”) specification (incorporated fully herein by reference), each implementation of the DOM may be client specific. Under the W3C DOM, all components within an HTML web page will be within the DOM. The software program that presents the rendered code, such as a web browser, can maintain its own set of rules on how the rendering is to be performed and what the final document will look like. In order to ensure the likelihood that component identification is accurate, the system should be “client-aware,” that is access the rendered code that would be presented to a client computer 12, by using the network 14 and server computer 16, or by rendering the code before utilizing the DOM parser. The system should have the ability to encapsulate, access, invoke or otherwise communicate with the parser specific to each supported rendering code. This may be achieved programmatically through a standard communication protocol, an application programming interface, translation layer or other means.

FIG. 4 shows one embodiment of the process of identifying page components, along with their associated methods and properties, using the DOM to extract hypertext links from rendered code. With reference to FIG. 4,

(a) The rendered code can be passed to an object, application, or other programmatic element that contains the DOM parser (circle 424).

(b) The parser (circle 424) returns the DOM for the code (block 426).

(c) The process can be used to query the DOM for a list of hyperlink components and related information or potentially other components (block 428).

(d) A collection of components along with their methods and properties can be returned (block 452). Again, this may be a collection based upon type of component, or an overall grouping of all components discovered.

Another parser other than the regular expression or DOM parsers may be used to identify components in code (see circle 444). Such means can include byte code parsing, character recognition, Boolean expressions, any other type of lexical or semantic analysis, or any other types of parsers which may or may not be currently known. Each process has inherent advantages and disadvantages; however, if the end result is similar to a collection of components, with or without methods and properties, the present invention may utilize this parser successfully as well. Just like the other parsers, component collections can then be returned (block 452).

Referring again to FIG. 4, after the code is parsed, a determination is made whether additional data is required (diamond 462). Identified components may have associated data values, in addition to their methods and properties, which require extraction from the code, including property values, actions, state information, unique identifiers, components, content, associated scripts, and other information. A conformance agent (circle 462) may be used to extract these values in a similar fashion to component identification, via regular expressions, the DOM, a combination of both, or an entirely different process. This additional component data can be returned (block 466) and posted in a data store (block 472). If additional data is not needed or desired (“No” branch of diamond 462), the component collections from block 452 can be posted to a data store (block 472).

In one example of gathering additional component data using the DOM, a valid statement for accessing a hyperlink component might resemble “window.document.anchors(0).” The resulting value of the HREF property of the anchor object can resemble “http://www.anysite.com.”

In contrast, a form, script, or applet may have multiple data components, such as fields, functions, or parameters. For example, a DOM query to retrieve the value of the search field might resemble the following instruction.

window.document.forms.item(“Form1”).components.item (“search”).value

The resulting value of the “search” element may resemble “search text.”

In addition to identifying components and their associated methods, properties, and data values, thorough analysis can also include information on the relationships between components and their context. The component-specific data, such as functional and performance data, can be further evaluated, arranged, viewed, tested, processed and presented. In particular, testing of the components of the application can provide enhanced test results as compared to prior solutions.

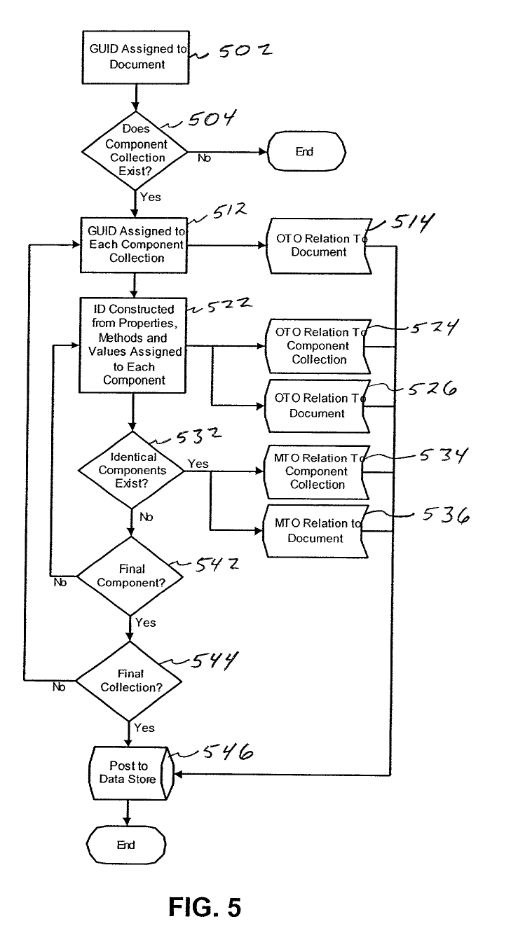

At this point, the process can be used for determining the relationships between the components as shown in FIGS. 5-7 and to be described in more detail below. Two types of relationships can be noted as contextual relationships and cross-contextual relationships.

A parent-child relationship may be defined wherein the component exists as a child, or sub-component, of the “container” in which it resides, such as a document, a network page, or the like (collectively referred to in FIGS. 5-7 as a “document”); the document is the parent while the component is the child. Similarly, methods, properties and data values may exist as sub-components of the component itself, such as the fields in a form and the values in each field. This creates a hierarchical model that accurately represents the nature of the components and their context.

FIG. 5 shows one embodiment of a process for determining contextual relationships among the identified components. The contextual relationship identification process can include assigning a Globally Unique IDentifier (“GUID”) to the document (block 502). The process can further include determining whether a component collection (which can comprise a single component) exists which corresponds to that document (diamond 504). If not, there are no children (i.e., sub-components) and the contextual relationship identification process ends. Otherwise, the process continues.

If at least one component collection exists, each component collection is assigned a GUID (block 512). A one-to-one (“OTO”) relationship between the component collection and the document from which the component collection came is then made (block 514). For each component within each component collection, an identifier can be constructed from the properties, methods, and values assigned to that component (block 522). This identifier can be created programmatically, for example using a checksum or CRC, or by using a DOM string or relative index, or by any other method which uniquely identifies each component. An OTO relationship between the component and its corresponding component collection can be made (block 524) and an OTO relationship between the component and the document can be made (block 526).

A determination may be made whether identical components exist (diamond 532). If identical components are discovered, a many-to-one (“MTO”) relationship between the component and each of the component collection (block 534) and document in which that component exists (block 536) are made.

The process can be iterated for all components within a component collection (diamond 542), and for all component collections corresponding to a document (diamond 544). Data regarding the contextual relationships can be posted to the data store (block 546).

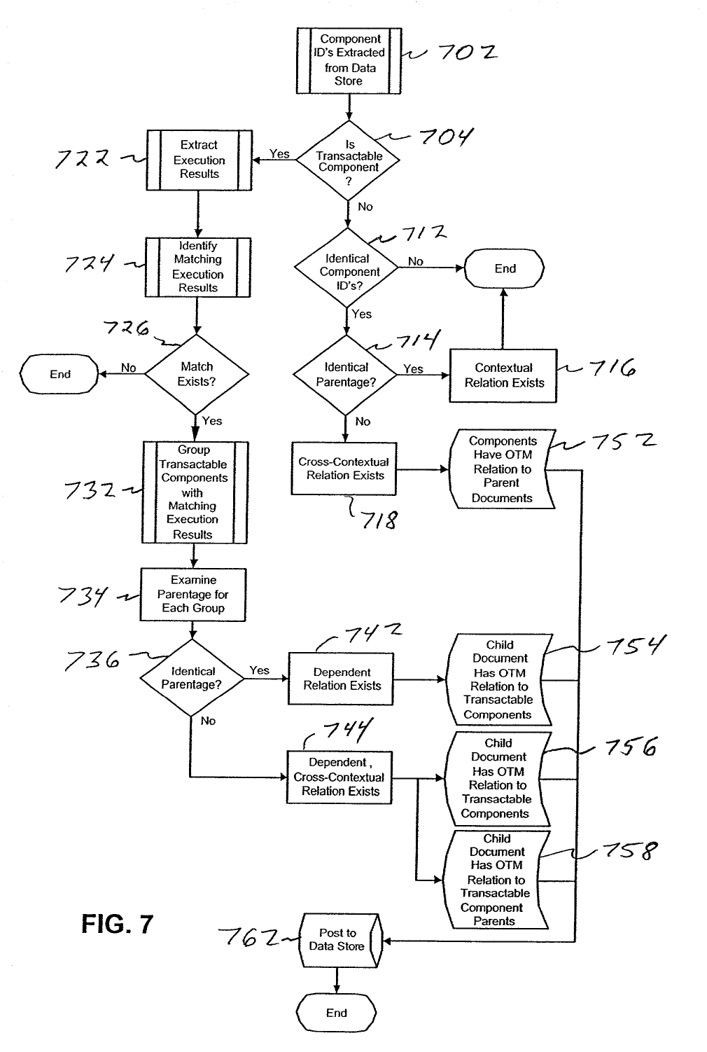

The component contextual relationship identification process may be further extended to include relationships between components in different contexts (defined herein as “cross-contextual relationships”), such as a form whose action property, when executed using input from the client computer 12, results in a new document being retrieved. The process can create a hybrid model that represents both hierarchical and dependent relationships. One embodiment of a process for determining cross contextual relationships between components will be described further herein (see FIG. 7).

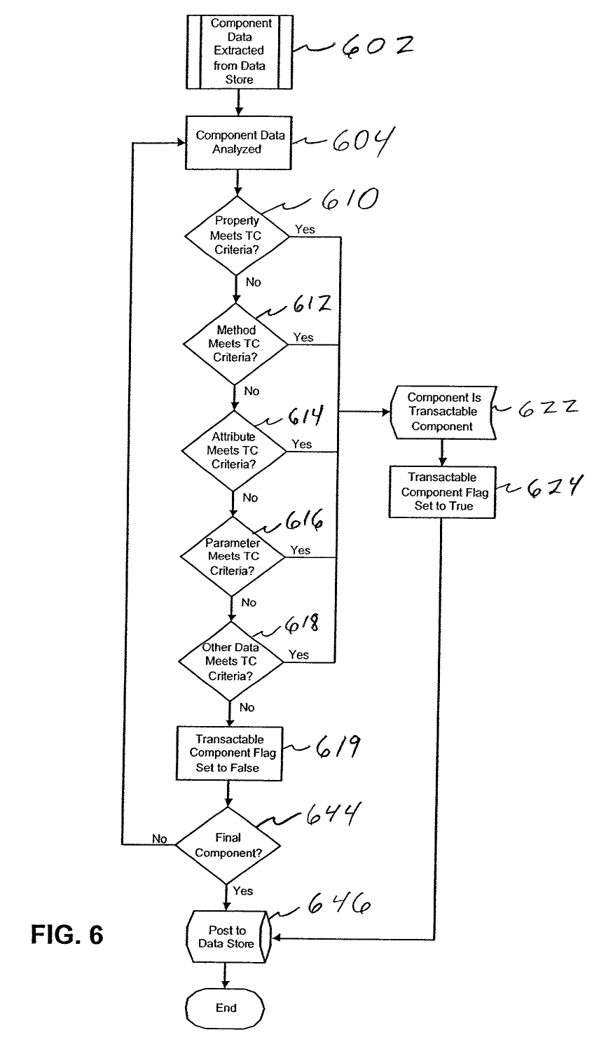

In addition to identifying components of a document or set of documents in an application, the system and method can further isolate transactable components from non-transactable components. FIG. 6 depicts one embodiment of the invention in which transactable components (TCs) can be identified by analyzing the properties, methods, attributes, parameters, and other component data. Hyperlinks, which lead the user to a destination or submit a specifically formatted request to a host, and forms, which collect data and submit it for processing, are both examples of transactable components. The system may be aware of what types of components are considered TCs, either by explicit definition or by analyzing the component properties, and may identify them as such upon discovery. A system may invoke a function and pass the component data directly or the function may extract the component data from the data store (block 602). After the component data is retrieved, the component data is analyzed (block 604). Each piece of component data is compared to established criteria associated with transactable components. These criteria may be related to the properties (diamond 610), methods (diamond 612), attributes (diamond 614), parameters (diamond 616), or other data (diamond 618) associated with a component. If any of the criteria is met (the “Yes” branches of the diamonds 610-618), component is a TC (block 622), and the transactable component tag for the component can be set to “True” (block 624). If none of the criteria is met (all “No” branches), the process can be used to set the flag to “False” (block 619). The process is iterated for the rest of the components remaining in the data store (diamond 644). Before ending this operation, the component information related to TCs can be posted to the data store (block 646).

Transactable components, like any other component, may be used repeatedly within a document. For purposes of properly identifying the relationships between the components of an application, especially in cases where a data set is associated with the component (as can be the case with forms and applets), each component should be uniquely identified in such a manner that, if the component is found in several locations, the system recognizes that a previously identified component is recurring and does not catalog a new component in the data store.

In one embodiment, after TCs have been identified and information regarding the TCs has been collected and stored, information regarding cross-contextual relationships among the components (including the TCs) may be generated as shown in FIG. 7. It should be understood that the process of identifying component relationships, both contextual and cross contextual, can be performed independently of isolating transactable components from non-transactable components. In the FIG. 7 embodiment, component identifiers can be extracted from the data store (block 702). A determination is made whether the component is a TC (diamond 704). If not, a determination is made whether another identical component identifier exists (diamond 712). If so (“No” branch from diamond 712), this portion of the process of FIG. 7 ends. Otherwise (“Yes” branch from diamond 712), a determination is made whether the identical components have identical parentage (diamond 714). If so (“Yes” branch of diamond 714), a contextual relationship exists (block 716). Otherwise (“No” branch of diamond 714), a cross-contextual relationship exists (block 718), and the identical components without identical parentage are noted as having a one-to-many (“OTM”) relationship to the parent documents (block 752).

If the component is a TC (“Yes” branch of diamond 704), execution results from the component are extracted (block 722), and components having matched execution results are identified (block 724). For example, two links in a document return the identical page when executed. If a match between the execution results does not exist (“No” branch of diamond 726), this portion of the process is ended. Otherwise (“Yes” branch of diamond 726), TCs can be grouped with according to their corresponding matching execution results (block 732).

Each grouping of TCs can be examined for its parentage (block 734). A determination can be made whether groups have identical parentage (diamond 736). If so (“Yes” branch of diamond 736), a dependent relationship exists (block 742), and a notation can be made that the child document has an OTM relationship to the TCs (block 754). Otherwise (“No” branch of diamond 736), dependent, cross-contextual relationships exist (block 744), and notations can be made that the child document has an OTM relationship to the TCs (block 756) and an OTM relationship to the TC parents (block 758). The notations from blocks 752-758 and the resulting dependency map can be posted in the data store (block 762). The process can be repeated for the rest of the TCs within the document, network page, or other container.

The unique identifiers used in relationship definitions may be based on such factors as component type, name, and number of fields, field types, field values, action, and so forth. These factors may be used to construct a value, derived from the computation of a component-specific algorithm, which may be represented as a checksum, numeric/alphanumeric value, or other means, to identify a one-to-one or one-to-many contextual relationship. This value can then be used to uniquely identify the object and associate it with any data values or related components.

Cross-contextual relationships may be defined by matching the value of a component with values that exist outside of the component's individual context as previously described. In some instances a many-to-one, cross-contextual relationship may exist if the same component exists in multiple contexts. In others, a one-to-one, cross-contextual relationship may be defined if the child of one parent can be directly related to a different parent component when an action, such as a form post or hyperlink, is executed. These instances are known as dependent relationships; the relationship is not explicitly defined (such as in a parent-child relationship) but rather inferred by the property, method, or action of a component.

Returning to FIG. 3, the embodiment of the testing process shown comprises generating a transaction definition (block 36). The transaction definition can define transactions that can be performed within the application. Unlike conventional methods, the transaction definition is not required to be a script file, and can therefore be a scriptless transaction. The transaction definition can contain information about the structure and sequence of the transaction. To define a scriptless transaction, the process may include the manual, automatic or programmatic collection of the following information.

(a) The components that comprise each step, along with any associated data value, validation mechanism, content, variable, action, property, rule, control message, or other appurtenance for the transaction.

(b) All information desired for executing the transaction in such a manner as to simulate the actual sequence of application actions, including GET and POST messages used in HTTP or similar protocols.

(c) Stateful information about the user, including cookies, session identifiers, custom URLs, or the like.

(d) Timing information, including the amount of user time spent on a particular step, response time, retrieval time, rendering time, delivery time, component execution time, or the like.

(e) Other miscellaneous information, including headers, size, character count, content and formatting, or the like, that may be necessary for proper transaction execution.

After the data is collected, this transaction information may be stored as one or more data elements in a computer file, document, database, or other storage mechanism (e.g., database 18). In one embodiment, navigation, visual component, or automatic definition may be used individually or in combination to collect the transaction information.

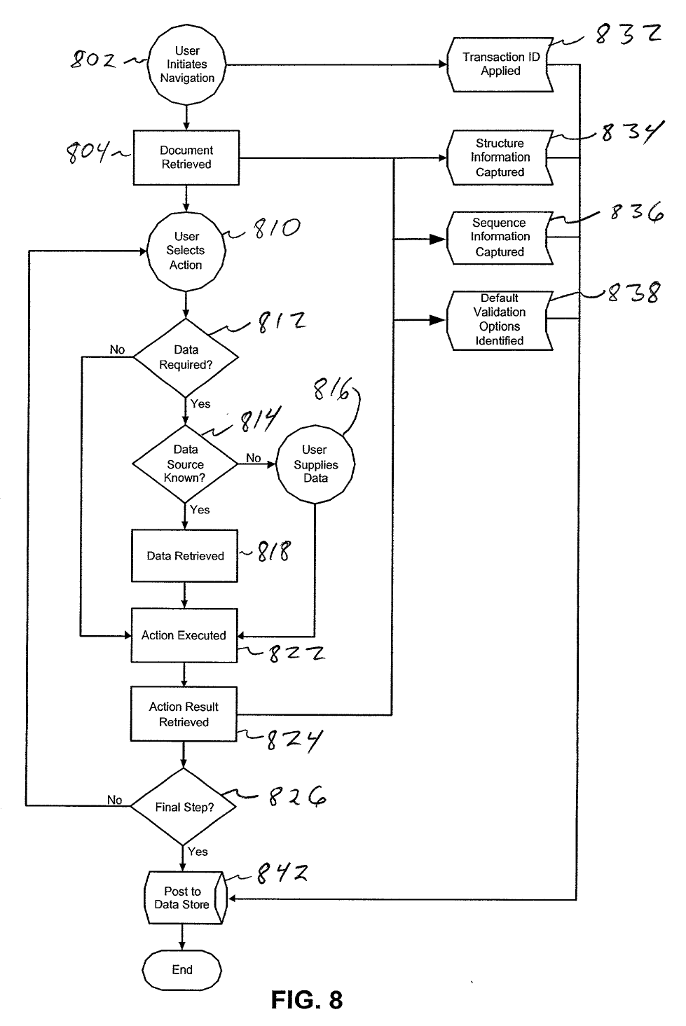

Attention is now directed to one embodiment of performing navigation definition as described below and illustrated in the process flow diagram in FIG. 8. Using navigation definition, the user at client computer 12 can collect transaction information by manually stepping through the transaction sequence in an application panel (typically via a browser) as transmitted from the server computer 16 via the network 14. The testing software at the client computer 12 can automatically create the transaction definition while the user engages in navigation activity. The structure of the transaction can be displayed in real-time in a separate but related panel through which the user may change, alter or provide additional details for each step in a transaction and any other information used to duplicate the user actions. Such a process does not require a programmer to write code. In many embodiments, the transaction definition can be generated by anyone capable of navigating using a browser.

Referring to FIG. 8, a user at client computer 12 can initiate navigation (circle 802). A transaction identifier may be applied to the navigation sequence (block 832). The process can continue with the server computer 16 retrieving a document (block 804) in response to navigation commands from the client computer 12. The user can select an action while using the document (block 810). The action is the step taken by the user (e.g., clicking on a link), while the transaction is the combination of the execution of the action by the user and the response received, including the associated data/files. A determination is made whether data is required (diamond 812). If not (“No” branch of diamond 812), the action is executed (block 824). Otherwise (“Yes” branch of diamond 812), a determination is made whether the data source is known (diamond 814). If not (“No” branch of diamond 816), the user may supply the data (block 816), and the action may be executed (block 822). If the data source is known (“Yes” branch of diamond 814), the data can be retrieved from the data source (block 818), and the action may be executed (block 822). The action result may be retrieved (block 824). The process is iterated until the final step (diamond 826).

During the navigation, information regarding the transaction being performed can be captured. For example, structure information may be captured (block 834) and sequence information may be captured (block 836). Default validation options may also be identified (block 838). The default validation reflects validation that may be performed without explicit instruction to do so. A default validation may be performed to determine that certain data, content, structure, or layout or other constructs are valid in isolation or with potentially with other components. For example, the default options can verify that content exists. In one example, a simple transaction may comprise a navigation action, executed via a hyperlink, in which the user moves from document A to document B. In this scenario, default validation may include verification that the target for the defined component action, in this case a hyperlink, exists within document A and that its HREF property leads to document B.

Before ending the process of FIG. 8, any part or all the information obtained during navigation may be posted to the data store (block 842).

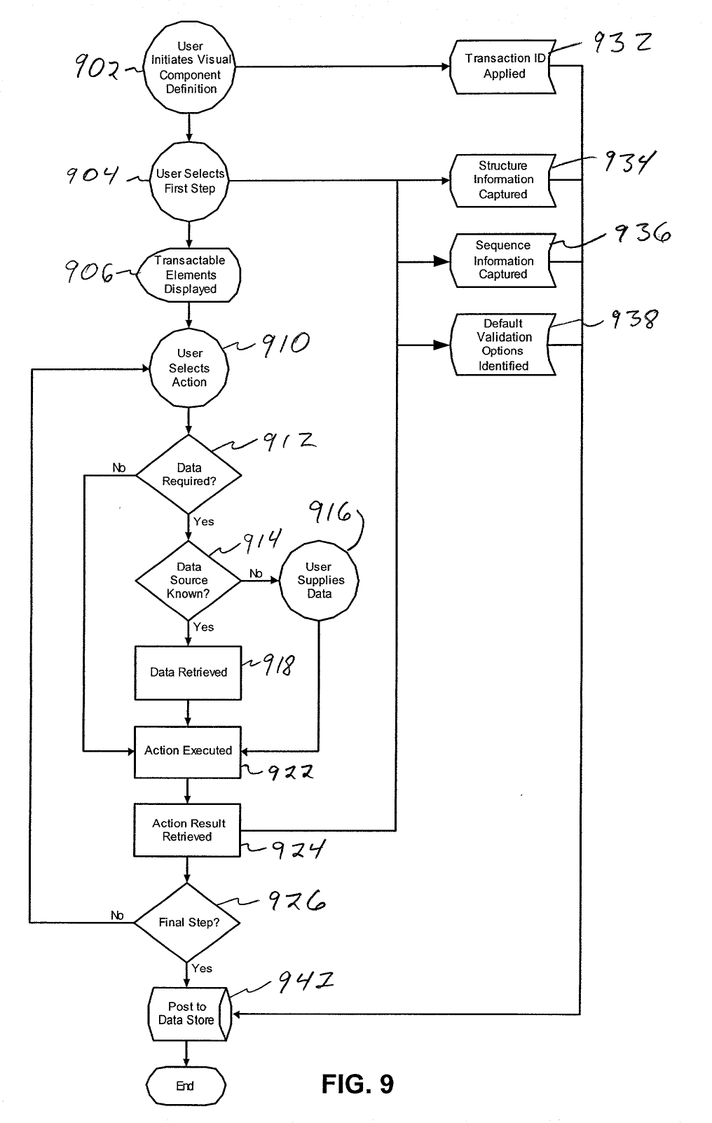

Alternatively, visual component definition may be used to collect transaction definition information, as described below and illustrated in the process flow embodiment of FIG. 9. Using visual component definition, the user at client computer 12 can select a starting location for the transaction and may be presented with representations of transactable components or transactions. The representations may include icons or may be a list of names of the transactable components. From this list, the user may select the desired component, thereby setting the action property for the step. The user at client computer 12 may click on the desired representations or use a drag-and-drop (also called click-and-move) operation. If any data is used in executing the action, the user may provide it manually, select from a list, retrieve from a data store, utilize a template, or use any other means desired. The structure of the transaction can be displayed to the user at client computer 12 in real-time in a separate but related panel through which the user may change, alter or provide additional detail for each step in a transaction and any other information desired to duplicate the user actions.

Referring to FIG. 9, a user at client computer 12 can initiate visual component definition (circle 902). A transaction identifier may be applied to the information to be collected during the process in FIG. 9 (block 932). The user at client computer 12 may select the first step (block 904). The process can continue with the client computer 12 displaying transactable components (block 906). The user can select an action by selecting one of the displayed transactable components (block 910). A determination is made whether data is required for the transactable component (diamond 912). If not (“No” branch of diamond 912), the action is executed (block 924). Otherwise (“Yes” branch of diamond 912), a determination is made whether the data source is known (diamond 914). If not (“No” branch of diamond 916), the user may supply the data (block 916), and the action may be executed (block 922). If the data source is known (“Yes” branch of diamond 914), the data can be retrieved from the data source (block 918), and the action may be executed (block 922). The action result may be retrieved (block 924). The process of FIG. 9 can be iterated over some or all of the transactable components in the application(diamond 926).

During the visual component definition process, transaction information can be captured. For example, structure information may be captured (block 934) and sequence information may be captured (block 936). Default validation options may also be identified (block 938). The default validation may be similar to the default validation described with respect to FIG. 8. Before ending this segment of the process, any part or all of the information obtained during navigation may be posted to the data store (block 942).

In an alternative, automated transaction definition may include nearly any process of transaction creation that does not require the user to manually create a transaction sequence using navigation, visual component or other similar definition processes. Automatic definition may be achieved through user-initiated process, such as log file processing, or a process controlled by the software, such as a relationship-based definition.

In one embodiment, transaction definitions may be created automatically by parsing log files for an application (e.g., web site) on server computer 16 that contain a record of each document visited by prior user(s) and what components were executed during an individual session. Because these logs, usually stored in a text file or relational database, can contain the URL of each ‘step’ taken by the user, the system can use this data to replicate the steps used to define a transaction chain. Transactable components within the chain are easily identifiable as execution points (such as a FORM post or hypertext link) in the logs.

In one embodiment, the process is as follows:

1. The user at client computer 12 can upload the log file from the server computer 16.

2. The client computer 12 can parse the log file and identifies those log entries that comprise individual transactions.

3. The client computer 12 can generate a base transaction definition using information contained in the log file.

4. The client computer 12 may a) display the transaction definitions to the user or b) schedule the transactions for execution.

5. The user may modify the structure, sequence or other parameters of the transaction prior to execution.

6. The user can select the discovered transactions to execute.

In another embodiment, the client computer 12 may analyze component relationships and dependencies as previously described to generate transaction definitions. In one such embodiment, the process is as follows:

1. The client computer 12 may extract those documents that have cross-contextual or dependent relationships defined in the data store.

2. The client computer 12 can isolate the transactable components in each document.

3. Based on previously defined content handling rules, the client computer 12 can generate a base transaction definition using the transactable components and relationship data.

4. The client computer 12 can populate transactable components that contain input fields with data from a template, data store or other source. Alternatively, the client computer 12 may populate inputs based on the properties of the input itself, such as type, length, format, etc.

5. The client computer 12 may a) execute the transaction(s) and records the results in the data store or b) display the transaction definitions to the user.

6. The user may modify the transaction definitions, scheduling information, or other parameters pre- or post-execution.

After the transaction definition has been generated, the process can further comprise validating the transaction(s) (block 38 in FIG. 3). Transaction validation can provide a means of ensuring that actual results encountered during transaction execution match the expected results from the transaction definition. This can be used to create a baseline against which comparative processes can determine the state of application performance and functionality. Validation rules may be applied individually or collectively to both documents and components, including all properties, methods, actions, values, content or other quantifiable parameters, as well as relationships, transactions, and other constructs. This process, which can be manual or automatic, may take place before, during, or after transaction definition.

In many cases, validation can be a comparative process that evaluates one numeric value against another, such as response time or document size, to produce a binary (true or false) result. However, it may also include other mechanisms for comparing non-numeric string values, such as Boolean, regular expression, or the like. Validation may also employ multiple operands, complex mathematical equations, hash algorithms, concatenations, encryption/decryption mechanisms and other means to determine the similarities between actual and expected results.

In some embodiments, much of the validation is performed on the document (integration of sub-components within a document) and component levels. Document and component validation will be addressed separately. For document validation, validation may be applied to the properties of a document, the DOM, or its content.

Referring to document validation, validation may be applied to any property of a document, including size, length, checksum, headers, type, cookies, and more. Values to which validation may be applied can be of nearly any type, such as integer, variant or string, and may be of fixed or variable length. Documents may also be validated in isolation, in groups or in aggregate and have specific or general formatting. Virtually any comparative process may be used to evaluate document property validation.

For DOM validation, if the client computer 12 can ascertain the DOM for the requested resource, the DOM may be used for validation purposes. DOM nodes, including all sub-nodes and their related information, may be validated in isolation, in groups or in aggregate. Information exposed by the DOM, such as the properties, methods and actions of individual components, may also be validated whether or not it is explicitly referenced within the document.

Generally, evaluation of DOM validation can be performed with a binary expression but, in some cases, additional comparative processes may be used.

Beyond property and DOM validation, advanced validation may be performed. Other types of values, such as the presence or absence of specific text strings, performance data (load, response, query time, etc.), content inclusions or exclusions, and a wide range of other parameters may also be validated in isolation, in groups, or in aggregate. Any comparative process may be used in accordance with the type of validation being applied.

Turning to component validation, it can be applied to the properties of a component, its methods and actions, or other parameters. While components may exist in the DOM of the document to which they are bound, they may not have their own object model and may not utilize DOM validation. However, component-specific analysis routines may expose structures that resemble an object model, in which case, those structures may be used for validation purposes.

Property validation at the component level may be applied to any property of a component, including name, size, checksum, type, location, and more. Values used in validation can be of nearly any type, such as integer, variant or string, and may be of fixed or variable length. They may also be validated in isolation, in groups or in aggregate and have specific or general formatting. Any comparative process may be used to evaluate component property validation.

For advanced validation, other types of values, such as the presence or absence of specific text strings, performance data (load, response, query time, etc.), content inclusions or exclusions, any structures exposed by component-specific analysis routines and a wide range of other parameters may also be validated in isolation, in groups or in aggregate. Nearly any comparative process may be used in accordance with the type of validation being applied.

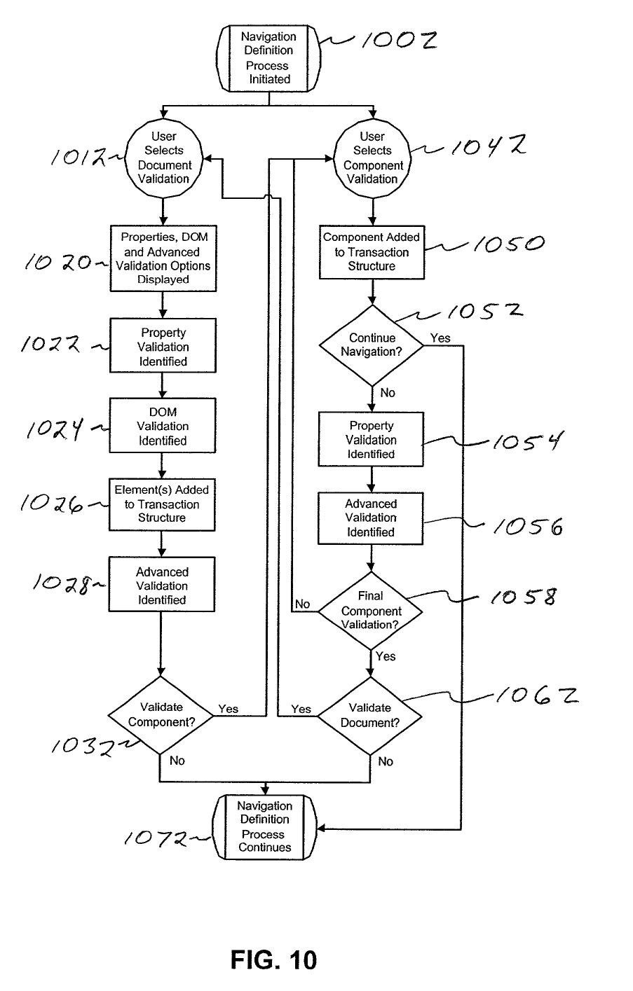

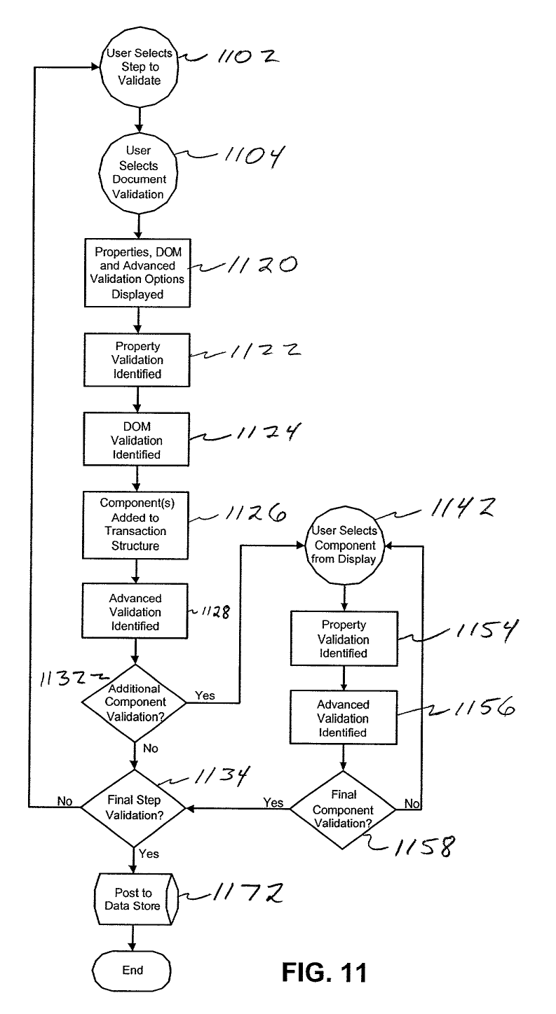

The various types of validation may be performed in-process or out-of-process. In-process validation is illustrated in the flow diagram in FIG. 10 and refers to validation that can be performed during transaction definition generation. Out-of-process validation is illustrated in the flow diagram in FIG. 11 and refers to validation that can be performed after the transaction definition process. In-process validation is often performed with navigation transaction definition. Out-of-process validation is often performed with automated transaction definitions. Still, any of the transaction definition processes can be used with in-process or out-of-process validation.

The application process for in-process validation may be manual, automated, or a combination of both. Once applied, in-process validation information may be stored with the transaction definition or as a separate data set.

In one embodiment, when a document is added to the transaction definition using one of the definition processes described above, the client computer 12 may automatically apply sufficient validation ensure that the document is uniquely identified, such as title, size, type and load time, while leaving the validation of other properties, including header, response time, and cookies, to the user's discretion.

Referring to the embodiment of in-process validation shown in FIG. 10, the user at client computer 12 may initiate a navigation transaction definition process (block 1002). The user may select document validation (circle 1012). Options regarding the validation may be displayed and include properties, DOM or advanced validation (block 1020). The property validation, DOM validation, and advanced validation to be used may be identified (blocks 1022, 1024, 1028) when navigating. Additionally, components may be added to the transaction structure (block 1026). A determination can then be made whether to validate a component (diamond 1032). If component validation is not to be done, the navigation transaction definition process can continue (block 1072). Otherwise (“Yes” branch of diamond 1032), the user can select component validation (circle 1042).

Alternatively, the user could start by selecting component validation (circle 1042). A component can be added to the transaction structure (block 1050). A determination can be made whether to continue navigation (diamond 1052). If yes, the navigation transaction definition process can continue (block 1072). Otherwise (“No” branch of diamond 1052), the property validation and advanced validation to be used may be identified (blocks 1054 and 1056) during navigation. At this time, the validation may be executed, and results from the validation posted to the data store. The process can be iterated for other components (diamond 1058). A determination is then made whether to validate a document (diamond 1062). If yes, the document validation is selected (circle 1012). Otherwise, the navigation transaction definition process can continue (block 1072). The abilities to switch between document and component validation and to validate during navigation give a user greater flexibility that with conventional processes.

One embodiment of the out-of-process validation is illustrated in FIG. 11. Out-of-process validation may be performed manually, automatically, or a combination of both. After the out-of-process validation has been applied, the resulting information may be stored with the transaction definition or as a separate data set.

In one embodiment, the user may complete the transaction definition, creating the sequence, structure and base validation to be used during execution. The user at client computer 12 may execute the transaction to ensure conformance, then modify the transaction by applying validation to a component's properties that were not included in the original definition. In another embodiment, the system may analyze the transaction structure post-definition and, based on predefined rules, apply validation automatically to documents or components meeting certain criteria.

Referring to the out-of-process validation shown in FIG. 11, the user at client computer 12 may select a step to validate (block 1102). Additionally, the user may select document validation (circle 1112). Options regarding the validation may be displayed and include properties, DOM or advanced validation (block 1120). The property validation, DOM validation, and advanced validation to be used may be identified (blocks 1122, 1124, 1128). Additionally, components may be added to the transaction structure (block 1126). At this time, the validation may be executed, and results from the validation posted to the data store. A determination can then made whether to validate an additional component (diamond 1132). If no, the validation process can be iterated through the final step (diamond 1134).

Otherwise (“Yes” branch of diamond 1132), the user can select component validation (circle 1142). The property validation and advanced validation for the component may be identified (blocks 1154 and 1156). The process can be iterated for other components (diamond 1158). A determination can then be made whether the process is at the final step of the validation in diamond 1134. If not, the iteration continues. Otherwise, all data collected during validation may be posted to the data store (block 1172), if this has not already occurred.

The process can further comprise modifying the transaction as shown in block 39 of FIG. 3. The optional modification allows flexibility in that modification can occur after a transaction has been defined and validation applied, the transaction may be modified, pre- or post-execution, at any step without the need to redefine the transaction from the beginning, which is seen with conventional script-based tests. In some cases, a step may be altered in such a way that the changes would not materially affect the nature of the transaction. In others, the steps preceding the change may remain constant while the subsequent steps would be altered in accordance with the change. For this specific example, validation does not need to be restarted, but is merely re-routed along a different set of transaction steps. In one specific, non-limiting embodiment, modification may be performed after validation has started but before validation is completed. In certain circumstances, the reverse may also occur, wherein the steps following a change remain constant and the preceding steps are altered. Such modifications may include changes to the structure, sequence, data, validation, or other parameters and take place as part of a manual or automated process.

For manual modification, the user at client computer 12 may manually modify the transaction definition by selecting a step from the display and changing an associated parameter, such as a property or component validation option. Such a change would not materially alter the nature of the transaction; the underlying data would be modified, and the transaction definition would remain intact. Should the user choose to change the action associated with a particular step, the subsequent steps may be removed, disabled or otherwise visually altered and the new result, if any, may be displayed. While such a change may materially affect the transaction definition it may or may not be necessary to treat the altered definition as a new transaction; the user may have the option of creating a new transaction definition from the changes or updating the existing definition.

An automated modification may occur when the client computer 12, via its software, alters the transaction definition in accordance with predefined rules and in response to an internal or external event without user intervention. In one embodiment, an “out of service” rule, put in place to handle regular maintenance cycles, may trigger the client computer 12 to alter the validation for the load time on each document and component in a transaction, wherein the load time may be adjusted upwards to compensate for the increased load placed on remaining in-service equipment. After the rule is no longer applicable, the client computer 12 may also return the validation options to their original values. With modifications, transaction definition versioning may be desired. The client computer 12 may maintain a historical record of each transaction definition such that, when a definition created the system records assigns a version identifier and stores certain metadata about the definition itself in the data store. Each time the definition is changed, the system increments the identifier, sometimes known as a version number, and records the changes as new metadata. This historical information may be used to track application changes, restore transaction definitions, rollback to previous definitions, and for a number of other purposes, all of which may be performed as a manual or automated process.

The various embodiments described above have improvements and advantages compared to conventional processes, and particularly to script recording processes. None of the improvements and advantages should be considered critical or a requirement of the invention.

Some of the improvements can include the following:

1. Real-time transaction definition—During navigation, much of a definition can be performed automatically by the system and displayed to the user in real time.

2. Drag and drop transaction definition—Transactions may be created by selecting application components and creating logical dependencies in a visual display without having to actually navigate the application in a browser.

3. In-process validation—Validation options may be set on-the-fly without requiring the user to edit a script after the definition process has been completed.

4. Component-level validation—Validation may be applied to the content, properties, methods, actions and other criteria of each component, ensuring that the transaction results during execution precisely match the definition.

5. Point and click modification—The underlying components of a definition may be modified at any step in the transaction without compromising the definition integrity and requiring a new definition (“re-recording”).

6. Programmatic modification—Transaction definitions may be modified automatically by programmatic functions in response to application changes, response values, validation failures, or other pre- and post-execution events.

7. Reusable definitions—The sequence, logic, validation, inputs, responses, content and data elements of a transaction may be reused, in whole or in part, for new definitions, eliminating the need to cut and pastel blocks of text from one script to another.

Many of the embodiments include scriptless transaction creation, modification, and execution and incorporate at least some of the improvements listed above. The embodiments can provide advantages over conventional processes and may include the following:

1. Simplified transaction definition—While real-time transaction definition can display the actual transaction structure during navigation, eliminating the need to analyze a script for proper logic and sequencing, drag and drop definitions may drastically reduce the amount of time required to create complex transactions by eliminating navigation altogether. In addition, many transactions can be created automatically by the system without user intervention.

2. Enhanced validation options—Component analysis methodology (described in detail with respect to FIGS. 4-7) may provide detailed validation options for each step in the transaction, resulting in better functionality and performance data and less time spent troubleshooting application errors.

3. Flexible modification—After a transaction has been defined and executed, it may be modified, either manually or automatically, at any point without affecting the overall definition. Definitions may be versioned and rolled back or forward in response to application changes or test scenarios. This greatly reduces the amount of time and number of resources required to manage existing definitions.

4. Increased return on investment—Scriptless transaction testing processes in accordance many of the previously described embodiments may require fewer resources while providing more and better information about application functionality and performance.

Although much of the description focused on the client computer 12, at least some of the process may be performed on the server computer 16. Additionally, software code used to perform the testing (transaction definition and validation) may reside in complementary portions on the client computer 12 and server computer 16.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

What is claimed is:

1. A process for testing an application, comprising:
generating a transaction definition for a transaction that can be performed using the application, wherein the transaction definition is not part of a script file; and
validating the transaction.

2. The process of claim 1, wherein generating a transaction definition further comprises navigating through a network site to sequentially step though portions of the network site accessed during the transaction itself.

3. The process of claim 1, further comprising identifying a first component within the application, wherein:
the first component is part, but not all, of a document; and
the first component is not a link.

4. The process of claim 3, further comprising identifying the first component as a first transactable component, wherein generating a transaction definition further comprises selecting the first transactable component.

5. The process of claim 4, wherein:
generating a transaction definition further comprises displaying information that comprises representations of a plurality of transactable components; and
the plurality of transactable components comprises the first transactable component.

6. The process of claim 4, further comprising:
identifying a second component within the application; and
determining relationship data between the first component and the second component,
wherein generating the transaction definition comprises generating the transaction definition using the relationship data.

7. The process of claim 1, further comprising accessing a log file for a network site, wherein generating the transaction definition is performed using information from the log file.

8. The process of claim 1, wherein generating the transaction definition comprises selecting the transaction by clicking on a representation of the transaction.

9. The process of claim 1, further comprising modifying the transaction.

10. The process of claim 9, wherein modifying is performed after validating starts but before validating is completed.

11. The process of claim 10, wherein after modifying, validating is continued without restarting validation from the beginning.

12. The process of claim 9, wherein modifying automatically changes the transaction definition, so that a step is added or removed from the transaction definition.

13. The process of claim 9, further comprising recording transaction versioning information.

14. A process for testing an application, the process comprising:
identifying a first component within the application, wherein:
the first component is part, but not all, of a document; and
the first component is not a link;
generating a transaction definition for a transaction that can be performed using the application; and
validating the transaction.

15. The process of claim 14, wherein generating comprises navigating through a network site to sequentially step though portions of the network site accessed during the transaction itself.

16. The process of claim 14, further comprising identifying the first component as a first transactable component, wherein generating comprises selecting the first transactable component.

17. The process of claim 16, wherein:
generating further comprises displaying information that comprises representations of a plurality of transactable components; and
the plurality of transactable components comprises the first transactable component.

18. The process of claim 16, further comprising:
identifying a second component within the application; and
determining a relationship datum between the first component and the second component,
wherein generating comprises generating the transaction definition using the relationship datum.

19. The process of claim 14, further comprising accessing a log file for a network site, wherein generating is performed using information from the log file.

20. The process of claim 14, wherein generating comprises selecting the transaction by clicking on a representation of the transaction.

21. The process of claim 14, further comprising modifying the transaction.

22. The process of claim 21, wherein modifying is performed after validating starts but before validating is completed.

23. The process of claim 22, wherein after modifying, validating is continued without restarting validation from the beginning.

24. The process of claim 21, wherein modifying automatically changes the transaction definition, so that a step is added or removed from the transaction definition.

25. The process of claim 21, further comprising recording transaction versioning information.

26. The process of claim 14, wherein identifying comprises parsing the application.

27. A data processing system readable medium having code embodied therein, the code is designed to test an application, the code comprising:
an instruction for generating a transaction definition for a transaction that can be performed using the application, wherein the transaction definition is not part of a script file; and
an instruction for validating the transaction.

28. The data processing system readable medium of claim 27, wherein the instruction for generating comprises an instruction to collect information as a user navigates through portions network of the site accessed during the transaction itself.

29. The data processing system readable medium of claim 27, wherein the code further comprises an instruction for identifying a first component within the application, wherein:
the first component is part, but not all, of a document; and
the first component is not a link.

30. The data processing system readable medium of claim 29, wherein the code further comprises an instruction for identifying the first component as a first transactable component, wherein the instruction for generating comprises an instruction for selecting the first transactable component.

31. The data processing system readable medium of claim 30, wherein:
the instruction for generating further comprises an instruction for displaying information that comprises representations of a plurality of transactable components; and
the plurality of transactable components comprises the first transactable component.

32. The data processing system readable medium of claim 30, wherein the code further comprises:
an instruction for identifying a second component within the application; and
an instruction for determining relationship data between the first component and the second component,
wherein the instruction for generating comprises an instruction for generating the transaction definition using the relationship data.

33. The data processing system readable medium of claim 27, wherein the code further comprises an instruction for accessing a log file for a network site, wherein the instruction for generating comprises an instruction to use information from the log file.

34. The data processing system readable medium of claim 27, wherein the instruction for generating comprises an instruction for receiving a click signal from a user, wherein the click signal corresponds to the transaction.

35. The data processing system readable medium of claim 27, wherein the code further comprises an instruction for modifying the transaction.

36. The data processing system readable medium of claim 35, wherein the instruction for modifying is executed after validating starts but before validating is completed.

37. The data processing system readable medium of claim 36, wherein after executing the instruction for modifying, validating is continued without restarting validation from the beginning.

38. The data processing system readable medium of claim 35, wherein the instruction for modifying is executed to automatically change the transaction definition, so that a step is added or removed from the transaction definition.

39. The data processing system readable medium of claim 35, wherein the code further comprises an instruction for recording transaction versioning information.

40. A process for testing an application, the data processing system readable medium comprising:
an instruction for identifying a first component within the application, wherein:
the first component is part, but not all, of a document; and
the first component is not a link;
an instruction for generating a transaction definition for a transaction that can be performed using the application; and
an instruction for validating the transaction.

41. The data processing system readable medium of claim 40, wherein the instruction for generating comprises an instruction to collect information as a user navigates through portions network of the site accessed during the transaction itself.

42. The data processing system readable medium of claim 40, wherein the code further comprises an instruction for identifying the first component as a first transactable component, wherein the instruction for generating comprises an instruction for selecting the first transactable component.

43. The data processing system readable medium of claim 42, wherein:
the instruction for generating further comprises an instruction for displaying information that comprises representations of a plurality of transactable components; and
the plurality of transactable components comprises the first transactable component.

44. The data processing system readable medium of claim 42, wherein the code further comprises:
an instruction for identifying a second component within the application; and
an instruction for determining a relationship datum between the first component and the second component,
wherein the instruction for generating comprises an instruction for generating the transaction definition using the relationship datum.

45. The data processing system readable medium of claim 40, wherein the code further comprises an instruction for accessing a log file for a network site, wherein the instruction for generating comprises an instruction to use information from the log file.

46. The data processing system readable medium of claim 40, wherein the instruction for generating comprises an instruction for receiving a click signal from a user, wherein the click signal corresponds to the transaction

47. The data processing system readable medium of claim 40, wherein the code further comprises an instruction for modifying the transaction.

48. The data processing system readable medium of claim 47, wherein the instruction for modifying is executed after validating starts but before validating is completed.

49. The data processing system readable medium of claim 48, wherein after the instruction for modifying is executed, validating is continued without restarting validation from the beginning.

50. The data processing system readable medium of claim 47, wherein the instruction for modifying automatically changes the transaction definition, so that a step is added or removed from the transaction definition.

51. The data processing system readable medium of claim 47, wherein the code further comprises an instruction for recording transaction versioning information.

52. The data processing system readable medium of claim 40, wherein the instruction for identifying comprises parsing the application.
